(19) United States
(12) Patent Application Publication
(10) Pub. No.: US 2026/0003194 A1
(43) Pub. Date: Jan. 1, 2026

(54) VIRTUAL IMAGE DISPLAY DEVICE AND OPTICAL UNIT

(71) Applicant: SEIKO EPSON CORPORATION, Tokyo (JP)

(72) Inventor: Mitsutaka IDE, SHIOJIRI-SHI (JP)

(73) Assignee: SEIKO EPSON CORPORATION, Tokyo (JP)

(21) Appl. No.: 19/246,706

(22) Filed: Jun. 24, 2025

(30) Foreign Application Priority Data
Jun. 26, 2024 (JP) 2024-102741

(51) Int. Cl. G02B 27/01

(52) U.S. Cl. CPC G02B 27/0172; G02B 2027/0178

(57) ABSTRACT

A direct virtual image type virtual image display device includes a display element, a first lens on which image light from the display element is incident, an angle suppression member disposed on an emission side of the first lens, a first prism on which the image light passing through the first lens is incident, a second prism joined to the first prism, an oblique mirror portion provided at a joint between the first prism and the second prism, and at least partially reflecting the image light guided in the first prism, a plano-convex second lens disposed to face an outer surface of the first prism, a transmissive mirror formed at a convex surface of the second lens and partially reflecting the image light, and a quarter wavelength plate disposed between the outer surface of the first prism and a flat surface of the second lens.

The present application is based on, and claims priority from JP Application Serial Number 2024-102741, filed Jun. 26, 2024, the disclosure of which is hereby incorporated by reference herein in its entirety.

### BACKGROUND

### 1. Technical Field

The present disclosure relates to a virtual image display device and an optical unit that make it possible to observe a virtual image.

### 2. Related Art

A head-mounted display including a display device, a projection optical member, a prism member, and a condensing and reflecting surface has been known in which image light from the projection optical member is incident on a first prism of the prism member, totally reflected by an outer surface, partially reflected by a semi-transmissive reflective surface formed at a boundary between the first prism and a second prism of the prism member, then transmitted through the outer surface of the prism member, reflected by the condensing and reflecting surface, returned to the prism member, transmitted through the semi-transmissive reflective surface, and further passing through an inner surface facing a pupil (see JP 2020-08749 A).

In the head-mounted display described above, since an intermediate image is formed in the first prism, there is a problem in that an optical path length becomes large and an optical system becomes large as a whole.

### SUMMARY

A direct virtual image type virtual image display device in an aspect of the present disclosure includes a display element configured to emit image light, a first lens on which the image light from the display element is configured to be incident, an angle suppression member disposed on an emission side of the first lens, a first prism on which the image light passing through the first lens is configured to be incident, a second prism joined to the first prism and forming a prism light guiding member having a parallel flat plate shape, an oblique mirror portion provided at a joint between the first prism and the second prism and configured to reflect at least a part of the image light guided in the first prism, a plano-convex second lens disposed to face an outer surface of the first prism on which the image light reflected by the oblique mirror portion is configured to be incident, a transmissive mirror formed above a convex surface of the second lens and configured to partially reflect the image light reflected by the oblique mirror portion toward the oblique mirror portion, and a quarter wavelength plate disposed between the outer surface of the first prism and a flat surface of the second lens.

A direct virtual image type optical unit in an aspect of the present disclosure includes a first lens on which image light from a display element that emits the image light is configured to be incident, an angle suppression member disposed on an emission side of the first lens, a first prism on which the image light passing through the first lens is configured to be incident, a second prism joined to the first prism and forming a prism light guiding member having a parallel flat plate shape, an oblique mirror portion provided at a joint between the first prism and the second prism and configured to reflect at least a part of the image light guided in the first prism, a plano-convex second lens disposed to face an outer surface of the first prism on which the image light reflected by the oblique mirror portion is configured to be incident, a transmissive mirror formed above a convex surface of the second lens and configured to partially reflect the image light reflected by the oblique mirror portion toward the oblique mirror portion, and a quarter wavelength plate disposed between the outer surface of the first prism and a flat surface of the second lens.

### BRIEF DESCRIPTION OF THE DRAWINGS

FIG. 1 is an external view for explaining a usage state of a virtual image display device of a first embodiment.

FIG. 2 is a side cross-sectional view for explaining an internal structure of the virtual image display device on one side.

FIG. 3 is a diagram for explaining shapes and the like of a first image forming element and a first lens.

FIG. 4 is a conceptual perspective view for explaining an angle suppression member.

FIG. 5 is a diagram for explaining a modification example of the angle suppression member.

FIG. 6 is a diagram for explaining another modification example of the angle suppression member.

FIG. 7 is a diagram for explaining dimensions and the like of a repeating structure of the angle suppression member.

FIG. 8 is a perspective view for explaining an external structure of a first display unit.

FIG. 9 is a diagram for explaining stray light caused by unexpected reflection.

FIG. 10 is a diagram for explaining another type of stray light caused by unexpected reflection.

FIG. 11 is a perspective view for explaining an example of a structure and assembly of the first display unit.

FIG. 12 is a side cross-sectional view for explaining a virtual image display device of a second embodiment.

FIG. 13 is a conceptual perspective view for explaining an angle suppression member illustrated in FIG. 12.

FIG. 14 is a diagram for explaining dimensions and the like of the repeating structure of the angle suppression member illustrated in FIG. 12.

FIG. 15 is a diagram for explaining an angle suppression member of a third embodiment.

FIG. 16 is a diagram for explaining an angle suppression member of a fourth embodiment.

FIG. 17 is a diagram for explaining a modification example of an angle suppression member illustrated in FIG. 16.

FIG. 18 is a diagram for explaining a modification example of the virtual image display device.

### DESCRIPTION OF EMBODIMENTS

### First Embodiment

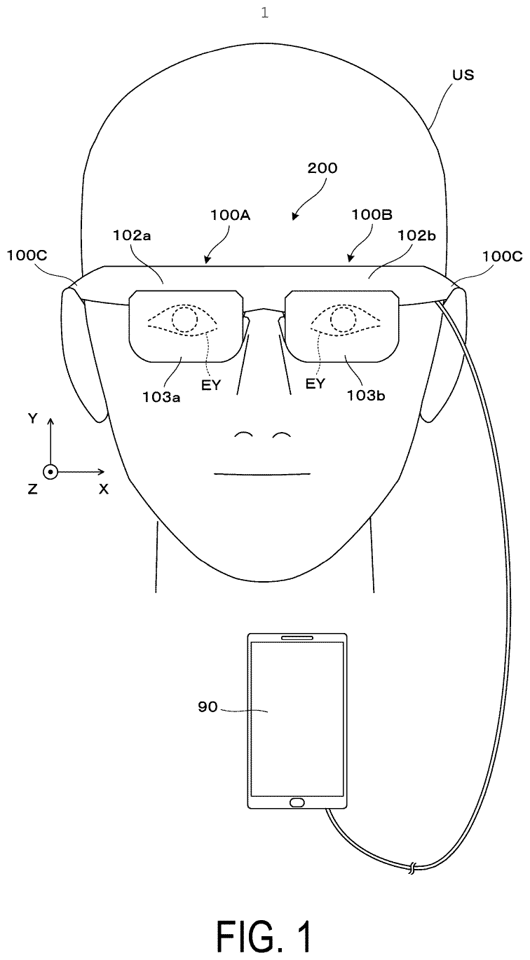

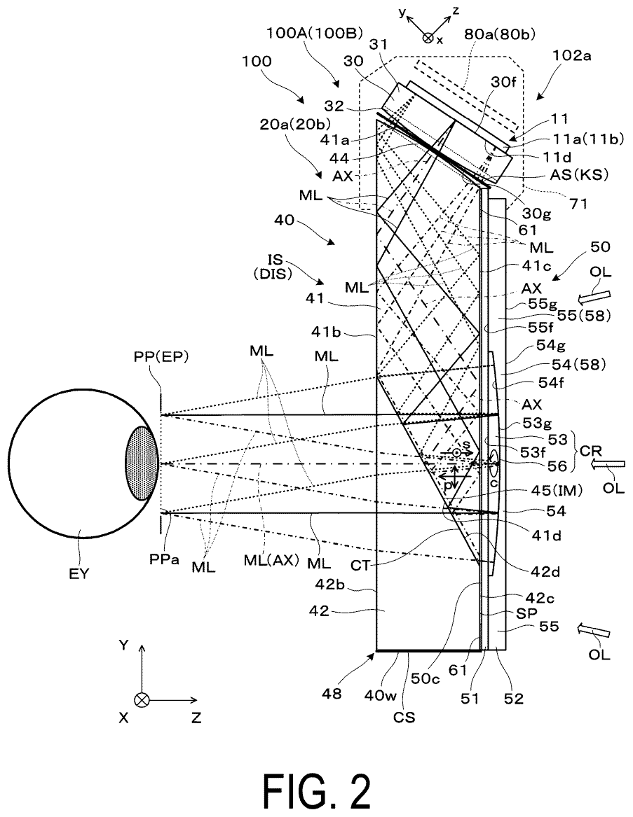

Below, a first embodiment of a virtual image display device and the like according to the present disclosure will be described with reference to FIGS. 1, 2 and the like.

FIG. 1 is a diagram for explaining a mounted state of a head-mounted virtual image display device (hereinafter, also referred to as a head-mounted display or an “HMD”) 200, and the HMD 200 enables an observer or wearer US, who is wearing the HMD 200, to recognize an image as a virtual image. In FIG. 1 and the like, X, Y, and Z represent a rectangular coordinate system. A +X direction corresponds to a lateral direction in which both eyes EY of the observer or the wearer US, who wears the HMD 200, are arranged. A +Y direction corresponds to an upper direction perpendicular to the lateral direction from a viewpoint of the wearer US in which both of the eyes EY are arranged. A +Z direction corresponds to a forward direction or a front side direction from the viewpoint of the wearer US. +Y directions are parallel to a perpendicular axis or a perpendicular direction.

The HMD 200 includes a direct virtual image type first virtual image display device 100A for a right eye, a direct virtual image type second virtual image display device 100B for a left eye, a pair of temple-type supporting devices 100C configured to support the virtual image display devices 100A and 100B, and a user terminal 90 that is an information terminal. The first virtual image display device 100A alone functions as an HMD, and includes a first display driving unit 102a disposed at an upper portion, and a first combiner 103a having a shape of a spectacle lens and covering a front of the eye. Similarly, the second virtual image display device 100B alone functions as an HMD, and includes a second display driving unit 102b disposed at the upper portion, and a second combiner 103b having a shape of a spectacle lens and covering a front of the eye. The supporting devices 100C are mounting members mounted on a head of the wearer US, and support upper end sides of the pair of combiners 103a and 103b via the display driving units 102a and 102b that are integrated in appearance. The first virtual image display device 100A and the second virtual image display device 100B are optically identical or left-right inverted, and a detailed description of the second virtual image display device 100B will not be given.

FIG. 2 is a side cross-sectional view for explaining an internal structure of the first virtual image display device 100A. The first virtual image display device 100A includes a first image forming element 11a, a first display unit 20a, and a first circuit member 80a. The first image forming element 11a is also referred to as a display element 11. The first display unit 20a is an imaging optical system IS that directly forms a virtual image without forming an intermediate image and is also referred to as a direct virtual image optical system DIS. The imaging optical system IS includes a first lens 30, an angle suppression member AS, a first flat plate member 40, and a second flat plate member 50. The first lens 30 has a function as a protective glass that protects a display surface 11d of the display element 11. Note that a cover glass may be provided between the display element 11 and the first lens 30. The angle suppression member AS limits an incident angle or an optical path of image light ML guided in the first flat plate member 40. Specifically, the angle suppression member AS shields or absorbs a light beam of the image light ML reflected by an unexpected number of reflections in a prism light guiding member 48, and limits the image light ML to a light beam internally reflected twice by a first prism 41. The first flat plate member 40 guides the image light ML emitted from the display element 11 to a second lens 53 of the second flat plate member 50. The second flat plate member 50 reflects the image light ML from the first flat plate member 40 toward a pupil position PP or the eye EY by partially returning the image light ML to the first flat plate member 40, and causes external light OL to be incident on the pupil position PP via the first flat plate member 40. Each of the first lens 30, the first flat plate member 40, and the second flat plate member 50 has a function as a lens having positive refractive power.

Although detailed description will be omitted, the second virtual image display device 100B includes a second image forming element 11b, a second display unit 20b, and a second circuit member 80b. The second image forming element 11b is similar to the first image forming element 11a, the second display unit 20b is similar to the first display unit 20a, and the second circuit member 80b is similar to the first circuit member 80a.

In the first virtual image display device 100A, the first image forming element 11a is an image-light generating device of a self-luminous type. The first image forming element 11a emits the image light ML to the first flat plate member 40 via the first lens 30. The first image forming element 11a is housed and supported in a case 71. The first image forming element 11a is, for example, an organic electro-luminescence (EL) display, and forms a color still image or moving image on the two-dimensional display surface 11d. The first image forming element 11a is driven by the first circuit member 80a to perform display operation. The first image forming element 11a is not limited to the organic EL display, and may be replaced with a display device using inorganic EL, an organic LED, an LED array, a laser array, a quantum dot light emission element, or the like. The first image forming element 11a is not limited to the image-light generating device of a self-luminous type, and it may be possible to employ a device including an LCD or other light modulating elements and illuminating the light modulating elements using a light source such as backlight to form an image. As for the first image forming element 11a, it may be possible to use liquid crystal on silicon (LCOS, LCOS is a registered trademark), or the like, instead of the LCD. Note that an optical device excluding the first circuit member 80a from the first virtual image display device 100A is referred to as an optical unit 100. It can also be said that the optical unit 100 includes a direct virtual image type optical system and is a portion corresponding to the direct virtual image optical system DIS constituting the first virtual image display device 100A.

The first display unit 20a includes the first lens 30, the angle suppression member AS, the first flat plate member 40, an oblique mirror portion IM, and the second flat plate member 50. In the first display unit 20a, the first lens 30 has positive refractive power, and the image light ML from the first image forming element 11a is incident thereon. The first lens 30 includes a light incident surface 30f being a flat surface joined to the first image forming element 11a and a light emission surface 30g being a convex surface. The light emission surface 30g is, for example, a spherical surface, but may be an aspherical surface having an axially symmetric shape. The first lens 30 can be divided into a parallel flat plate 31 and a lens portion 32 for consideration. By ensuring that a thickness of the parallel flat plate 31 is equal to or greater than a predetermined value, foreign matter adhering to a surface of the first lens 30 becomes less noticeable. The parallel flat plate 31 has a function as a cover glass. The lens portion 32 is a plano-convex lens having positive refractive power. In the plano-convex lens, one surface has a flat surface shape and another surface has a convex surface shape. Note that the parallel flat plate 31 and the lens portion 32 may be glued to each other or may be separated from each other. The lens portion 32 need not be a plano-convex lens and may be, for example, a biconvex lens. Additionally, the first lens 30 is made of, for example, fused quartz and has a relatively low refractive index.

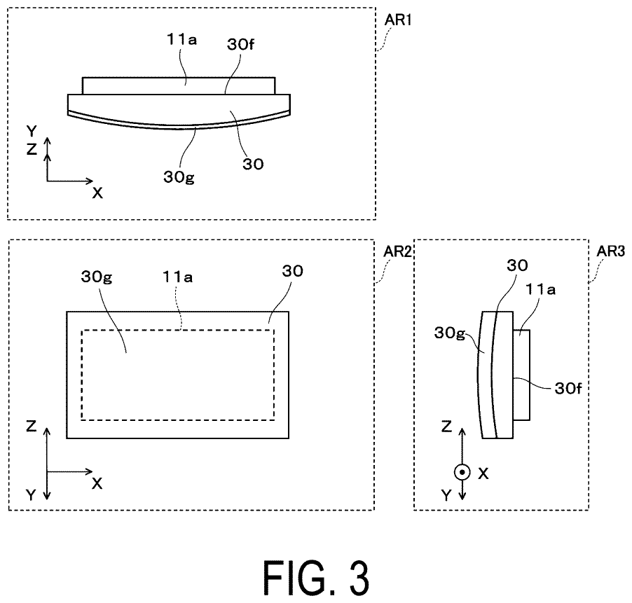

FIG. 3 is a diagram for explaining shapes and the like of the first image forming element 11a and the first lens 30. In FIG. 3, a region AR1 illustrates a state in which the first lens 30 and the like are viewed obliquely upward from a front +Z side, a region AR2 illustrates a state in which the first lens 30 and the like are viewed obliquely forward from a lower −Y side, and a region AR3 illustrates a state in which the first lens 30 and the like are viewed from a lateral +X side.

Referring back to FIG. 2, the first flat plate member 40 includes the first prism 41 having a parallel flat plate shape and a second prism 42 having a parallel flat plate shape. The first prism 41 and the second prism 42 are joined at inclined surfaces 41d and 42d. The first prism 41 and the second prism 42 are joined and are referred to as the prism light guiding member 48. The prism light guiding member 48 has an appearance of a parallel flat plate. The planar oblique mirror portion IM is formed above the inclined surface 41d formed below the first prism 41. A combination of the prism light guiding member 48 and the second flat plate member 50 described later corresponds to the first combiner 103a in FIG. 1.

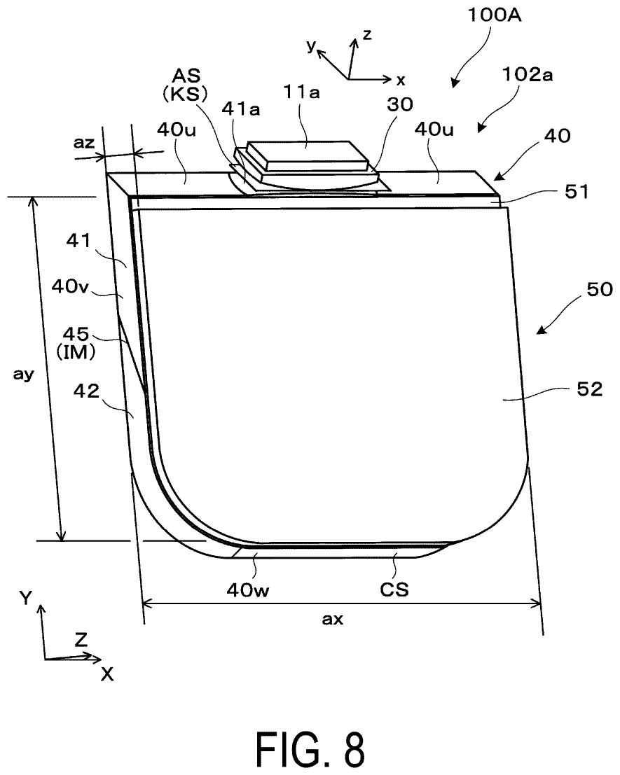

The first prism 41 has a square columnar outer shape and a trapezoidal longitudinal cross-section. The first prism 41 guides the image light ML, and includes an incident optical surface 41a, an inner surface 41b, an outer surface 41c, and the inclined surface 41d. Further, the first prism 41 includes an upper flat surface 40u and a part of a lateral flat surface 40v which will be described later (see FIG. 8 and the like). Here, the incident optical surface 41a is inclined downward on a front side as a whole, and an optical axis passing through the incident optical surface 41a extends in a direction between the +Z direction which is the front side direction and the +Y direction which is the upper direction. Accordingly, the first image forming element 11a which is the display element 11 can be easily disposed on an outside world side with respect to the inner surface 41b, and it is possible to adjust an angle at which the image light ML is propagated in the first prism 41 (inside the first prism 41 or an inside of the first prism 41). The incident optical surface 41a is a convex surface, for example a spherical surface, but may also be an axially symmetric aspherical surface. The first prism 41 can be considered to include a lens portion 44 including the incident optical surface 41a. The lens portion 44 is a plano-convex lens having positive refractive power. The lens portion 44 may be directly formed at the first prism 41 or may be glued to the first prism 41. The inner surface 41b and the outer surface 41c are parallel to each other, and extend perpendicularly to an optical axis AX between the pupil position PP and these surfaces. The inner surface 41b and the outer surface 41c internally reflect the image light ML (that is, reflection inside object surfaces), but particularly desirably totally reflect the image light ML. By applying a hard coat to the inner surface 41b, scratch resistance or abrasion resistance can be enhanced. The inclined surface 41d is a flat surface. The inclined surface 41d forms an acute angle with respect to the outer surface 41c, to be specific, an angle of 25° to 32°. Note that an interval between the optical axis AX passing through the pupil position PP and an upper end of the first lens 30 is about 20 mm. The first prism 41 is formed of a resin material.

The number of reflections of the image light ML in the first prism 41 is once at the inner surface 41b, once at the outer surface 41c, and once at the oblique mirror portion IM described later. By setting the number of internal reflections of the image light ML in the first prism 41 to two, it is possible to avoid mixing of light having different numbers of reflections in the first prism 41 while increasing an angle of view of the image light ML, the pupil position PP, or an opening PPa thereof.

The second prism 42, similarly to the first prism 41, has a square columnar outer shape and a trapezoidal longitudinal cross-section. The second prism 42 transmits the image light ML, and includes an inner surface 42b, an outer surface 42c, and the inclined surface 42d. Further, the second prism 42 includes a part of the lateral flat surface 40v and a lower flat surface 40w which will be described later (see FIG. 8 and the like). Here, the inner surface 42b and the outer surface 42c are parallel to each other, and extend perpendicularly to the optical axis AX between the pupil position PP and these surfaces. Scratch resistance can be enhanced by applying a hard coat to the inner surface 42b. The second prism 42 is formed of a resin material.

The oblique mirror portion IM reflects at least a part of the image light ML guided in the first prism 41. The oblique mirror portion IM is integrally formed above the inclined surface 41d of the first prism 41, and is sandwiched between the inclined surface 41d of the first prism 41 and the inclined surface 42d of the second prism 42. A space between the oblique mirror portion IM and the inclined surface 42d is filled with an adhesive CT for joining. The oblique mirror portion IM and the inclined surface 42d may be glued to each other by an adhesive film or the like, not limited to the gluing by the adhesive CT. In the embodiment, the oblique mirror portion IM is a polarization separation film 45. The polarization separation film 45 is formed of a dielectric multilayer film, and when the image light ML includes s-polarized light s, efficiently reflects the image light ML being s-polarized light s, and when the image light ML includes p-polarized light p, efficiently transmits the image light ML being p-polarized light p. It is sufficient that the polarization separation film 45 is a film that selectively reflects the image light ML in accordance with a polarization direction, and may be, for example, a wire grid polarizer or a reflective polarizing element using film stretching.

Note that the polarization separation film 45 may transmit s-polarized light s and reflect p-polarized light p.

It is sufficient that the oblique mirror portion IM includes a surface that is flat to an extent that image formation is not affected. In addition, the oblique mirror portion IM may include a slightly curved surface that is convex or concave to an extent that imaging is not affected. Note that a space between the oblique mirror portion IM and the inclined surface 41d may be filled with a filler having optical transparency instead of the adhesive CT. In this case, the first prism 41 and the second prism 42 may be supported by a support member or the like from outside to maintain a joined state. Further, the oblique mirror portion IM may be integrally formed above the inclined surface 42d of the second prism 42 instead of the inclined surface 41d of the first prism 41. Scratch resistance or abrasion resistance of the oblique mirror portion IM can be enhanced by applying a hard coat to a surface thereof.

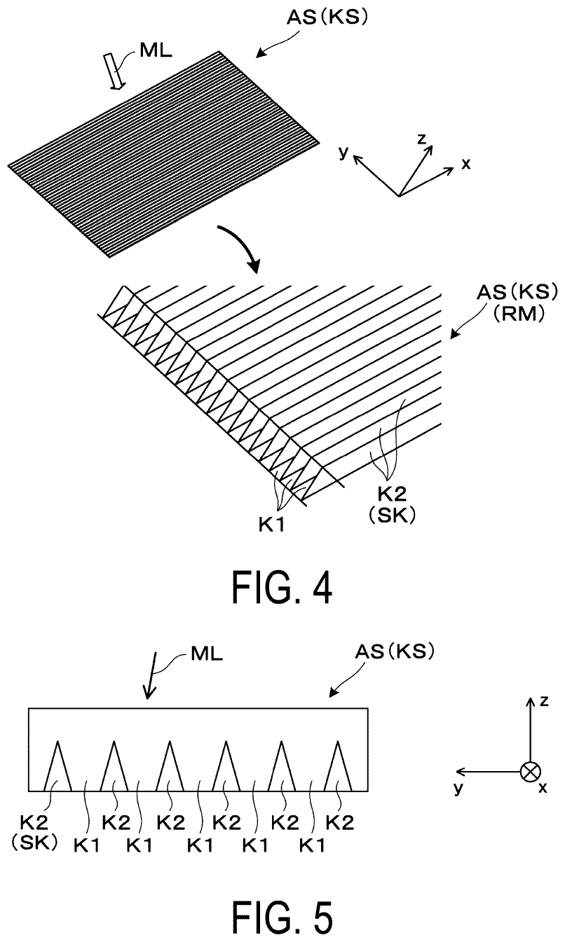

FIG. 4 is a conceptual perspective view for explaining the angle suppression member AS. Coordinates x, y, and z illustrated in FIGS. 2, 4, and the like are local coordinates of the angle suppression member AS. An x-axis of a local coordinate system substantially coincides with an X-axis of a global coordinate system. The angle suppression member AS controls an angle of light intersecting the x-axis perpendicular to a longitudinal cross-section of the prism light guiding member 48. The longitudinal cross-section of the prism light guiding member 48 is a cross section in a short direction of the incident optical surface 41a of the prism light guiding member 48. In the embodiment, the angle suppression member AS is disposed on an emission side of the first lens 30, specifically, between the first lens 30 and the first prism 41. Thus, the angle suppression member AS limits the incident angle of the image light ML incident on the first prism 41. It is sufficient that the angle suppression member AS is disposed between the first prism 41 and the display element 11, however, as the display element 11 is approached, a pitch of a repeating structure KS to be described later becomes smaller, which causes diffraction and a manufacturing problem. Therefore, it is desirable that the angle suppression member AS is disposed near the first prism 41. The angle suppression member AS shields or absorbs light having a predetermined angle with respect to the optical axis AX, that is, light having a predetermined incident angle. The light having the predetermined incident angle is light reflected by an unexpected number of reflections in the prism light guiding member 48 and causes stray light.

A size of the angle suppression member AS corresponds to the first lens, and is the same or substantially the same as a size of the first lens 30. An inclination angle of the angle suppression member AS corresponds to the first lens 30 or the lens portion 44 of the first prism 41, and is the same or substantially the same as an inclination angle of the first lens 30 or an inclination angle of the lens portion 44 of the first prism 41. That is, the angle suppression member AS extends along the first lens 30 or the lens portion 44 of the first prism 41. Accordingly, the angle suppression member AS easily adjusts an incident angle of the image light ML incident on the first prism 41.

The angle suppression member AS is a plate member or a film-like member having the light shielding repeating structure KS extending in a predetermined direction. The repeating structure KS is formed by alternately disposing a transmission region K1 or a light transmission layer which transmits the image light ML and a light shielding region K2 or a light shielding layer which shields or absorbs the image light ML having a predetermined incident angle. Specifically, the angle suppression member AS is a louver member RM or a louver-like film in which a plurality of elongated slats or slat-like members are arranged in parallel or substantially in parallel. It is sufficient that the repeating structure KS includes two or more light shielding regions K2 at the angle suppression member AS so as to shield or absorb the image light ML having the predetermined incident angle.

In the embodiment, the light shielding region K2 extends in an x direction of the local coordinate system. The x direction is a direction perpendicular to a cross-section of the prism light guiding member 48 or the first prism 41. The light shielding regions K2 are arrayed, as the repeating structure KS, at a predetermined pitch P and a predetermined height T. By adjusting the pitch P and the height T of the repeating structure KS, it is possible to appropriately shield or absorb a light beam of the image light ML having an angle at which stray light is generated. The light shielding region K2 may be inclined with respect to a surface of the angle suppression member AS. Further, the pitches P of the light shielding regions K2 may be constant or may have a predetermined pattern. In addition, the height T of the light shielding region K2 may be the same as a thickness of the angle suppression member AS or the transmission region K1, or may be smaller than the thickness of the angle suppression member AS or the transmission region K1.

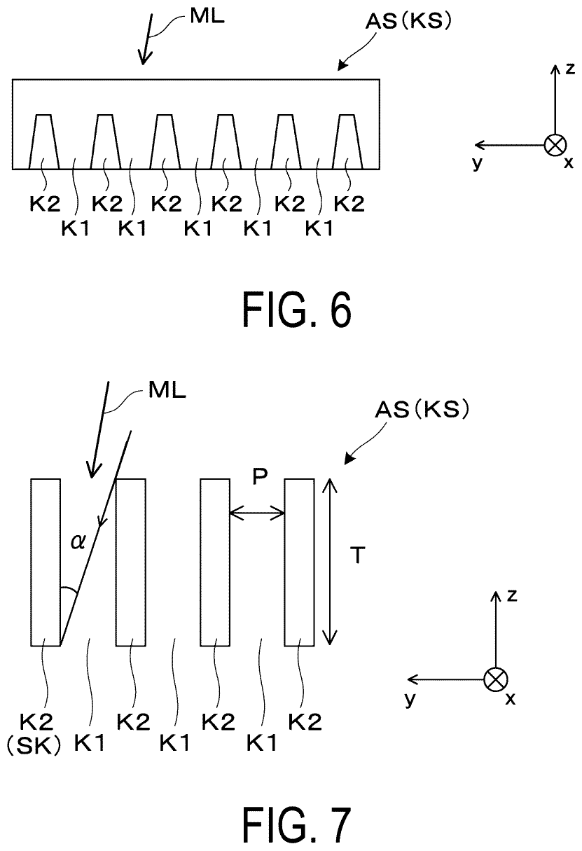

The light shielding region K2 is a light shielding body SK having a quadrangular shape in cross-sectional view. Accordingly, the design of the repeating structure KS can be simplified. The shape of the light shielding body SK can be changed as appropriate. For example, as illustrated in FIGS. 5 and 6, the light shielding region K2 may be the light shielding body SK having a trapezoidal shape, a triangular shape, or the like in cross-sectional view. A material of the light shielding body SK is, for example, carbon nanoblack, an antireflection material, a resin colored in black, or the like. The transmission region K1 is formed of transparent film, resin, or the like. The angle suppression member AS may be formed, for example, by providing grooves at equal intervals at a surface of a plate member or a sheet member having optical transparency and pouring the material of the light shielding body SK, or may be formed using a printing technique such as ink jet. In addition, the angle suppression member AS may be formed by alternately disposing transparent silicone rubber and black silicone and sandwiching them between polycarbonate films or the like. Note that a hard coat, an antireflection film, or the like may be applied to the surface of the angle suppression member AS. The angle suppression member AS may be formed by attaching an angle control film, a viewing angle control film, or the like to the light emission surface 30g of the first lens 30 or the incident optical surface 41a of the first prism 41.

FIG. 7 is a diagram for explaining dimensions and the like of the repeating structure KS of the angle suppression member AS. The repeating structure KS is defined by a minimum incident angle α of light of the image light ML desired to be shielded and the height T or the pitch P of the light shielding region K2 or the light shielding body SK. A relationship among the incident angle α, the height T, and the pitch P can be expressed by the following equation.

$$tan α = P / T$$

In the repeating structure KS, when the minimum incident angle α of the light desired to be shielded is determined and the height T or the pitch P is determined, the pitch P or the height T is inevitably determined. In the embodiment, the heights T and the pitches P of the repeating structure KS, that is, the light shielding regions K2 or the light shielding bodies SK are substantially constant. For example, when the repeating structure KS shields a light beam having the incident angle α equal to or greater than 18°, the height T of the light shielding region K2 or the light shielding body SK is about 50 μm, and the pitch P of the light shielding region K2 or the light shielding body SK is about 16.25 μm.

Referring back to FIG. 2, the second flat plate member 50 includes a thin-plate-like quarter wavelength plate 51 and a cover member 52. The quarter wavelength plate 51 is a crystal or the like having an optical axis between the X direction and a Y direction, converts the image light ML being s-polarized light s reflected by the polarization separation film 45 into circularly polarized light c, and converts the image light ML being circularly polarized light c reflected by the cover member 52 into p-polarized light p. The cover member 52 includes the plano-convex second lens 53, a plano-concave compensation lens 54, a compensation flat plate 55 provided around the compensation lens 54 and extending parallel to the prism light guiding member 48, and a transmissive mirror 56.

The second flat plate member 50 is disposed so as to be separated from the first flat plate member 40 by about 20 μm to 50 μm. The outer surfaces 41c and 42c of the first flat plate member 40, and an inner surface 50c of the second flat plate member 50 may be slightly curved, and a minute step may be formed at a boundary between the outer surfaces 41c and 42c, however, by setting an interval between the outer surfaces 41c and 42c, and the inner surface 50c to be equal to or greater than 20 μm, more desirably equal to or greater than 30 μm, it is possible to prevent these surfaces from being excessively close to each other. On the other hand, by setting the interval between the outer surfaces 41c and 42c, and the inner surface 50c to be equal to or less than 50 μm, it is possible to avoid an increase in a thickness of the first combiner 103a obtained by adding thicknesses of the first flat plate member 40 and the second flat plate member 50. Between the outer surfaces 41c and 42c of the first flat plate member 40 and the inner surface 50c of the second flat plate member 50, there is provided a spacer 61 for adjusting an interval between the first flat plate member 40 and the second flat plate member 50 and fixing the flat plate members in a mutually positioned state. The spacer 61 is not provided over an entire circumference of the second flat plate member 50. That is, a gap SP between the first flat plate member 40 and the second flat plate member 50 is not sealed and communicates with the outside world.

In the cover member 52, the second lens 53 is thin but has positive refractive power, and includes a flat surface 53f joined to the quarter wavelength plate 51 and a convex surface 53g facing the compensation lens 54. The convex surface 53g is, for example, a spherical surface, but may be an axially symmetric aspherical surface. The compensation lens 54 is thin but has positive refractive power and includes a concave surface 54f facing the second lens 53, and a flat surface 54g. The compensation flat plate 55 is a parallel flat plate, and includes a pair of flat surfaces 55f and 55g. Here, the concave surface 54f of the compensation lens 54 has the same shape as the convex surface 53g of the second lens 53. The flat surface 54g of the compensation lens 54 and the flat surface 55g of the compensation flat plate 55 are on the same plane and continuous. The transmissive mirror 56 is a thin film formed above the convex surface 53g of the second lens 53, and has the same shape as the convex surface 53g. A combination of the second lens 53 and the transmissive mirror 56 is referred to as a condensing and reflecting portion CR.

The second lens 53, the compensation lens 54, and the compensation flat plate 55 are made of a resin material and have the same refractive index. The refractive index of the second lens 53 and the like is lower than a refractive index of the first prism 41. The compensation lens 54 and the compensation flat plate 55 are an optical element 58 integrally formed of the same resin material.

A combination of the second lens 53, the compensation lens 54, and the compensation flat plate 55 functions as a parallel flat plate as a whole. That is, the external light OL incident on a position of the compensation lens 54 or the compensation flat plate 55 passes through the compensation lens 54 or the compensation flat plate 55 without being affected by a lens action by the compensation lens 54 or the like or by a step present at an outer edge of the compensation lens 54. In this way, the compensation lens 54 optically compensates for influence of the second lens 53 on the external light OL. In this sense, the flat surface 53f of the second lens 53, the flat surface 54g of the compensation lens 54, and the flat surfaces 55f and 55g of the compensation flat plate 55 are not necessarily limited to strictly flat surfaces, and may be, for example, substantially flat surfaces or partially or entirely include curved surfaces. In addition, the flat surface 53f of the second lens 53, the flat surface 54g of the compensation lens 54, and the flat surfaces 55f and 55g of the compensation flat plate 55 may each include a curved surface for correcting vision of the wearer US, or a curved surface as a design as in sunglasses or fashion glasses as far as inconvenience in terms of optical performances is not caused. The flat surfaces 54g and 55g of the compensation lens 54 and the compensation flat plate 55 may be provided with an antireflection film or a hard coat. The external light OL that is to pass through the compensation flat plate 55 is to pass through upper, lower, left, or right side of the compensation lens 54, and is incident from a peripheral region outside an incident region of the image light ML corresponding to the compensation lens 54, that is, from the compensation flat plate 55. This makes it possible to ensure a wide see-through field of view with respect to the outside world. A visual field range of the external light OL is set to, for example, about 40° in an upward direction and about 40° in a downward direction.

The transmissive mirror 56 is a half mirror, partially reflects the image light ML passing through the second lens 53, and partially transmits the external light OL. The transmissive mirror 56 reflects the image light ML reflected by the oblique mirror portion IM of the first flat plate member 40 or the polarization separation film 45, and passing through the quarter wavelength plate 51 and the second lens 53 toward the pupil position PP. The transmissive mirror 56 is a concave mirror that covers the pupil position PP at which the eye EY or a pupil is disposed, has a concave shape toward the pupil position PP, and has a convex shape toward the outside world. The pupil position PP or the opening PPa thereof is referred to as an eye point or an eye box, and corresponds to an emission pupil EP of the first display unit 20a.

Since the transmissive mirror 56 transmits a part of the external light OL, see-through view of the outside world is enabled, and a virtual image can be superimposed on an external image. At this time, the external light OL passes through the first flat plate member 40 and the second flat plate member 50, but the flat plate members 40 and 50 do not cause a lens action on the external light OL. A reflectance of the transmissive mirror 56 with respect to the image light ML and the external light OL is set to from 10% to 50% in a range of an incident angle of the assumed image light ML from the viewpoint of ensuring brightness of the image light ML and facilitating observation of an external image by see-through. The transmissive mirror 56 is formed of, for example, a dielectric multilayer film configured of a plurality of dielectric layers having an adjusted film thickness. The transmissive mirror 56 may be a single-layer film or a multilayer film of metal such as Al or Ag having an adjusted film thickness. The transmissive mirror 56 is formed by, for example, lamination using vapor deposition.

In the first virtual image display device 100A, each of the first lens 30, the lens portion 44, the second lens 53, and the transmissive mirror 56 has positive refractive power and causes divergent light to have a tendency to converge. The first lens 30, the lens portion 44, the second lens 53, and the transmissive mirror 56 together with a main body of the first prism 41, the second prism 42, and the like function as the imaging optical system IS or the direct virtual image optical system DIS such as a single-type microscope that forms an erect image. Thus, a real image formed on the display surface 11d of the first image forming element 11a can be projected, for example, at infinity to form a virtual image, or a real image formed on the display surface 11d can be projected several meters ahead to form a virtual image. At this time, by adjusting refractive power of each of the first lens 30, the lens portion 44, the second lens 53, and the transmissive mirror 56, it is possible to shorten a focal length of the imaging optical system IS and achieve a desired magnification ratio.

Referring to FIG. 8, a size ay in a vertical direction of the first flat plate member 40 or the second flat plate member 50 is, for example, 34 mm, and a size ax in a lateral direction thereof is, for example, 40 mm. A thickness az of the first flat plate member 40 in a front-rear direction is, for example, about 7 mm, and a thickness obtained by adding thicknesses of the first flat plate member 40 and the second flat plate member 50 is suppressed to about 7.5 mm. In the first flat plate member 40, the upper flat surfaces 40u are provided on left and right sides of the incident optical surface 41a. Light is not allowed to be incident on the upper flat surface 40u. From the viewpoint of preventing stray light, a light shielding body (not illustrated) may be disposed at the upper flat surface 40u so as to face and cover the upper flat surface 40u, or the light shielding body may be applied. The lateral flat surface 40v and the lower flat surface 40w may also be provided with light shielding bodies or the like for covering these flat surfaces. In the embodiment, the lower flat surface 40w which is a bottom surface of the prism light guiding member 48 or the second prism 42 is provided with a light shielding member CS. A light shielding body or the like covering a periphery of the second flat plate member 50 can also be provided.

Referring back to FIG. 2 to explain about optical paths, the image light ML from the first image forming element 11a enters the first prism 41 via the first lens 30 and the angle suppression member AS. At this time, a degree of divergence of the image light ML is suppressed by the positive refractive power of the first lens 30 and the lens portion 44. In addition, when the image light ML passes through the angle suppression member AS, a light beam having a predetermined angle which causes stray light is shielded or absorbed. In an optical path passing through the first prism 41, the image light ML is sequentially reflected by the inner surface 41b of the first prism 41 and the outer surface 41c of the first prism 41 without forming an intermediate image, and an s-component of the image light ML is reflected by the polarization separation film 45. The image light ML being s-polarized light s reflected by the polarization separation film 45 is transmitted through the outer surface 41c of the first prism 41 and passes through the quarter wavelength plate 51 of the second flat plate member 50 to become circularly polarized light c, and is incident on the transmissive mirror 56. A part of the image light ML being circularly polarized light c incident on the transmissive mirror 56 passes through the second lens 53, is reflected by the transmissive mirror 56, passes through the second lens 53, and passes through the quarter wavelength plate 51 again in a collimated state. Accordingly, the image light ML passing through the quarter wavelength plate 51 becomes p-polarized light p, is incident on the first prism 41 from the outer surface 41c, is transmitted through the polarization separation film 45, and is emitted outward the second prism 42 via the inner surface 42b. The image light ML emitted outward the second prism 42 enters the pupil position PP at which the eye EY or the pupil of the wearer US is disposed. Not only the image light ML reflected by the transmissive mirror 56 but also the external light OL transmitted through the transmissive mirror 56 and the external light OL passing through the compensation flat plate 55 are incident on the pupil position PP. In other words, the wearer US wearing the first virtual image display device 100A can observe a virtual image of the image light ML in a state where it is superimposed on an external image.

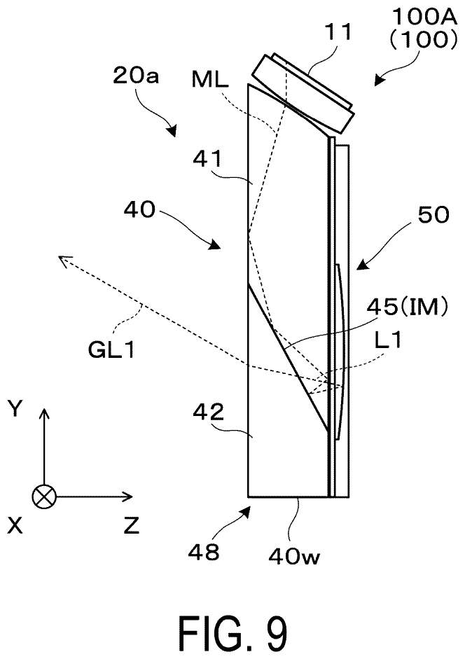

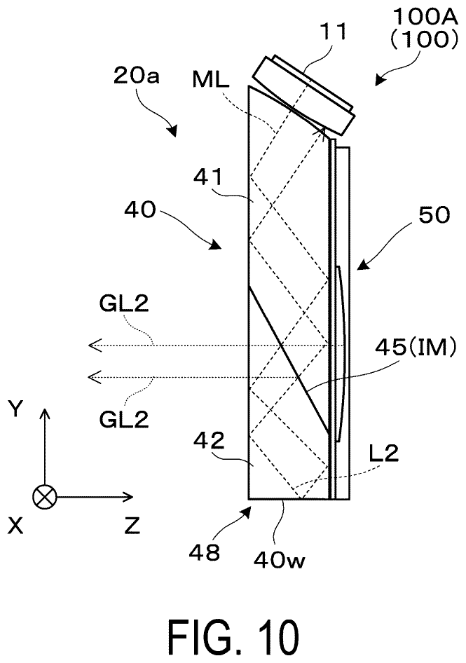

FIGS. 9 and 10 are diagrams for explaining stray light caused by unexpected reflection in the prism light guiding member 48. Since the first virtual image display device 100A is an optical system that does not include a diaphragm, when a visual field angle of the display element 11 is widened, there is a possibility that stray light reflected by an unexpected number of reflections is generated in the prism light guiding member 48 and an image with good image quality cannot be displayed to the wearer US. As illustrated in FIG. 9, light L1 reflected on an unexpected or non-designed path in the first prism 41 generates stray light GL1 or a ghost below a center of an image observed by the wearer US. This stray light GL1 can be prevented by the angle suppression member AS illustrated in FIG. 2 and the like. Additionally, as illustrated in FIG. 10, light L2 reflected by the lower flat surface 40w of the second prism 42 generates stray light GL2 or a ghost above the center of the image observed by the wearer US. The stray light GL2 can be prevented by providing the light shielding member CS above the lower flat surface 40w of the second prism 42 illustrated in FIG. 2 and the like.

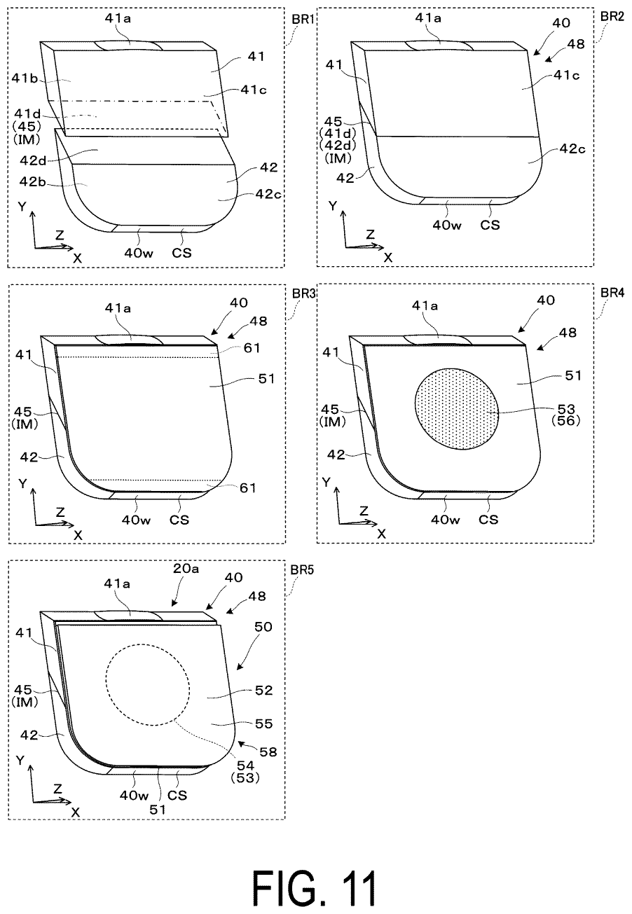

With reference to FIG. 11, an example of a structure and assembly of the first display unit 20a constituting the first virtual image display device 100A will be described. In FIG. 11, a region BR1 to a region BR5 are perspective views explaining assembly processes of the first display unit 20a. First, as illustrated in the region BR1, the first prism 41 and the second prism 42 are prepared. The first prism 41 and the second prism 42 are formed by injection molding of resin, for example. The first prism 41 is formed with the incident optical surface 41a, the inner surface 41b, the outer surface 41c, and the like. The second prism 42 is formed with the inner surface 42b, the outer surface 42c, and the like. Above the inclined surface 41d of the first prism 41, the polarization separation film 45 as the oblique mirror portion IM is formed by vacuum evaporation or another method. Above the lower flat surface 40w of the second prism 42, the light shielding member CS is formed by coating or another method. As illustrated in the region BR2, the first prism 41 and the second prism 42 are joined to each other at the inclined surfaces 41d and 42d to obtain the prism light guiding member 48 or the first flat plate member 40. Next, as illustrated in the region BR3, the quarter wavelength plate 51 is attached to face the outer surfaces 41c and 42c of the first flat plate member 40. At this time, a pair of the spacers 61 which are thin adhesives are disposed between the outer surfaces 41c and 42c of the first flat plate member 40, and the quarter wavelength plate 51, so that a gap is formed between the outer surfaces 41c and 42c of the first flat plate member 40, and the quarter wavelength plate 51. As illustrated in the region BR4, the second lens 53 is attached to an appropriate position above a surface of the quarter wavelength plate 51. A surface of the second lens 53 is formed with the transmissive mirror 56. Next, as illustrated in the region BR5, the optical element 58 is glued to the quarter wavelength plate 51 and the like. At this time, the compensation lens 54 of the optical element 58 and the second lens 53 are positioned, fitted, and joined to each other. In addition, the compensation flat plate 55 of the optical element 58 and the quarter wavelength plate 51 are joined to each other. As described above, the assembly of the first flat plate member 40 and the second flat plate member 50 in the first display unit 20a is completed.

In the above description, the first display unit 20a is produced so that the second flat plate member 50 is assembled above the first flat plate member 40, however, the first flat plate member 40 and the second flat plate member 50 may be separately assembled, and the first flat plate member 40 and the second flat plate member 50 may be finally joined to each other.

The direct virtual image type virtual image display device 100A, 100B, or the optical unit 100 of the first embodiment described above includes the display element 11 configured to emit the image light ML, the first lens 30 on which the image light ML from the display element 11 is incident, the angle suppression member AS disposed on the emission side of the first lens 30, the first prism 41 on which the image light ML passing through the first lens 30 is incident, the second prism 42 joined to the first prism 41 and forming the prism light guiding member 48 having a parallel flat plate shape, the oblique mirror portion IM provided at the joint between the first prism 41 and the second prism 42 and configured to reflect at least a part of the image light ML guided in the first prism 41, the plano-convex second lens 53 disposed to face the outer surface 41c of the first prism 41 on which the image light ML reflected by the oblique mirror portion IM is incident, the transmissive mirror 56 formed above the convex surface 53g of the second lens 53 and configured to partially reflect the image light ML reflected by the oblique mirror portion IM toward the oblique mirror portion IM, and the quarter wavelength plate 51 disposed between the outer surface 41c of the first prism 41 and the flat surface 53f of the second lens 53.

In the virtual image display devices 100A and 100B or the optical unit 100 described above, in order to directly form a virtual image without forming an intermediate image, refractive power is ensured by the first lens 30, the second lens 53, and the transmissive mirror 56, and thus an enlargement ratio is ensured while suppressing an increase in an optical path length, and an increase in a size of an optical system can be avoided. In addition, by providing the angle suppression member AS, it is possible to prevent occurrence of unnecessary unexpected reflection in the prism light guiding member 48 and to reduce stray light caused by the unexpected reflection.

### Second Embodiment

A virtual image display device and the like according to a second embodiment will be described below. The virtual image display device according to the second embodiment is provided by partially modifying the virtual image display device according to the first embodiment. Thus, description of portions common to the virtual image display device according to the first embodiment will be omitted.

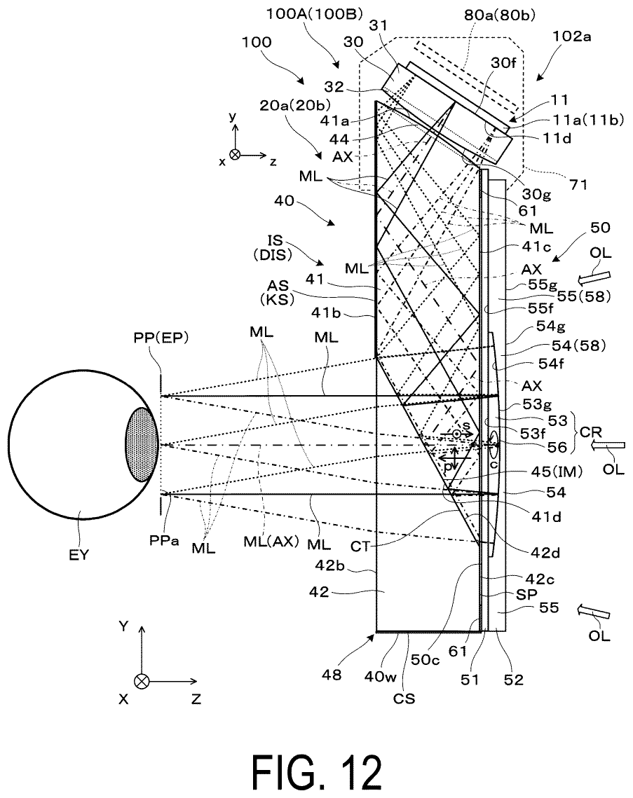

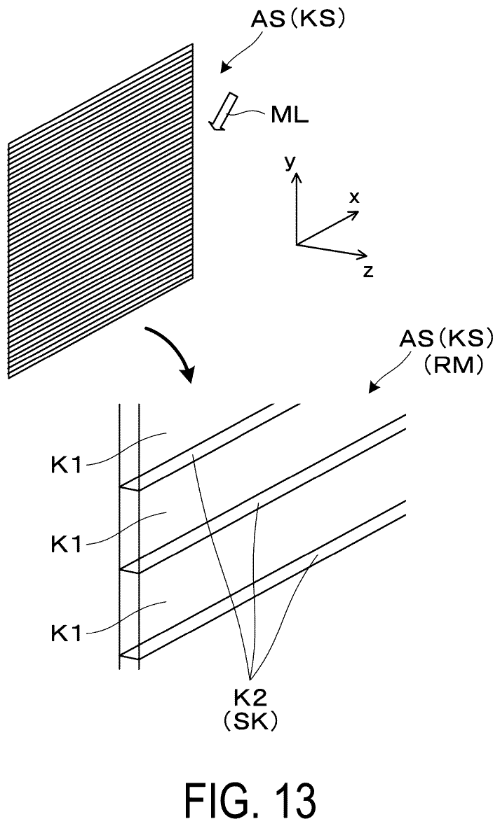

FIG. 12 is a side cross-sectional view for explaining an internal structure of the first virtual image display device 100A of the second embodiment. FIG. 13 is a conceptual perspective view for explaining the angle suppression member AS. A local coordinate system of the angle suppression member AS illustrated in FIG. 12 and the like substantially coincides with a global coordinate system illustrated in FIG. 12. In the first display unit 20a of the first virtual image display device 100A, the angle suppression member AS is disposed on the pupil position PP side of the first prism 41. That is, the angle suppression member AS is provided at the inner surface 41b of the first prism 41. This makes it possible to further suppress stray light. The angle suppression member AS may be provided at an entirety of the inner surface 41b of the first prism 41 or may be provided at a part of the inner surface 41b.

The angle suppression member AS may be formed by attaching a plate member or a film-shaped member to the inner surface 41b of the first prism 41, or may be formed by producing a groove when the first prism 41 is molded, and pouring the material of the light shielding region K2 or the light shielding body SK (such as resin having a light shielding property) into the groove.

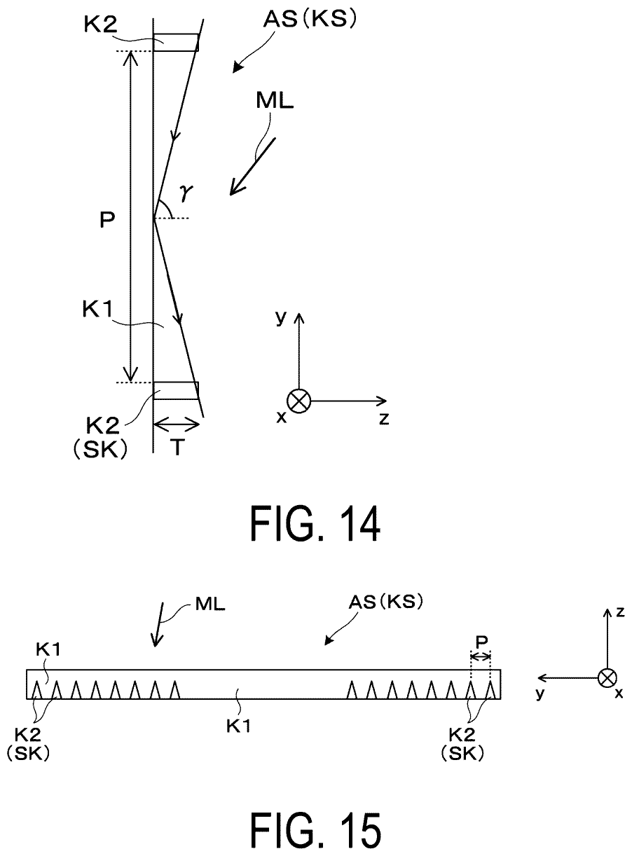

FIG. 14 is a diagram for explaining dimensions and the like of the repeating structure KS of the angle suppression member AS. In the embodiment, the pitch P of the repeating structure KS is set in consideration of reflection at the inner surface 41b of the first prism 41. As illustrated in FIG. 14, the image light ML incident on the angle suppression member AS has a larger allowable incident angle than the image light ML incident on the angle suppression member AS of the first embodiment illustrated in FIG. 7. Therefore, the pitch P of the repeating structure KS illustrated in FIG. 14, that is, the light shielding region K2 or the light shielding body SK becomes wider than the pitch P illustrated in FIG. 7. Thus, the angle suppression member AS can suppress influence of diffraction while improving manufacturing aspects. However, since the first prism 41 is included in a see-through portion for observing an external image, the pitch P is adjusted to such an extent that the external light OL which is see-through light does not cause large diffraction. In the repeating structure KS, a relationship among a minimum incident angle γ of light desired to be shielded out of the image light ML, the height T, and the pitch P can be expressed by the following equation.

$$tan γ = ( P / 2 ) / T$$

Specifically, the height T is about 50 μm, and the pitch P is about equal to or greater than 150 μm.

### Third Embodiment

A virtual image display device and the like according to a third embodiment will be described below. The virtual image display device according to the third embodiment is provided by partially modifying the virtual image display device according to the first embodiment. Thus, description of portions common to the virtual image display device according to the first embodiment will be omitted.

FIG. 15 is a diagram for explaining the angle suppression member AS provided at the first virtual image display device 100A of the third embodiment. As illustrated in FIG. 15, in the repeating structure KS of the angle suppression member AS, the pitch P changes according to a generation location of stray light. For the pitch P of the repeating structure KS, overall image brightness observed by the wearer US is also taken into account. In the embodiment, the light shielding region K2 of the repeating structure KS is the light shielding body SK having any one of a triangular shape and a trapezoidal shape embedded in the transmission region K1 in cross-sectional view. In addition, in the angle suppression member AS, a total area of the light shielding region K2 at a center is smaller than a total area of the light shielding regions K2 at both ends in a direction perpendicular to a predetermined direction in which the repeating structure KS extends.

When the light shielding region K2 of the repeating structure KS or the light shielding body SK has a trapezoidal or triangular shape, a light shielding surface is increased, so that overall image brightness is reduced. Therefore, the light shielding region K2 is disposed at a portion which does not give a large brightness change to an image while shielding light caused by stray light. For example, when stray light is generated in a portion of about one third on one side of the display element 11, the light shielding region K2 is not disposed at the center or a central portion of the angle suppression member AS, and the light shielding regions K2 are disposed only at both ends of the angle suppression member AS. With such a configuration, brightness at a center of an image does not change, and brightness at both ends of the image gradually decreases. Therefore, it is not necessary to increase brightness of an image displayed by the display element 11.

As described above, by forming the light shielding region K2 as the triangular or trapezoidal light shielding body SK, the repeating structure KS can be easily produced, and by suppressing light shielding in a vicinity of the center of the angle suppression member AS where influence of stray lights is small, it is possible to prevent a brightness change of an entire image from becoming large.

### Fourth Embodiment

A virtual image display device and the like according to a fourth embodiment will be described below. The virtual image display device according to the fourth embodiment is provided by partially modifying the virtual image display device according to the first embodiment. Thus, description of portions common to the virtual image display device according to the first embodiment will be omitted.

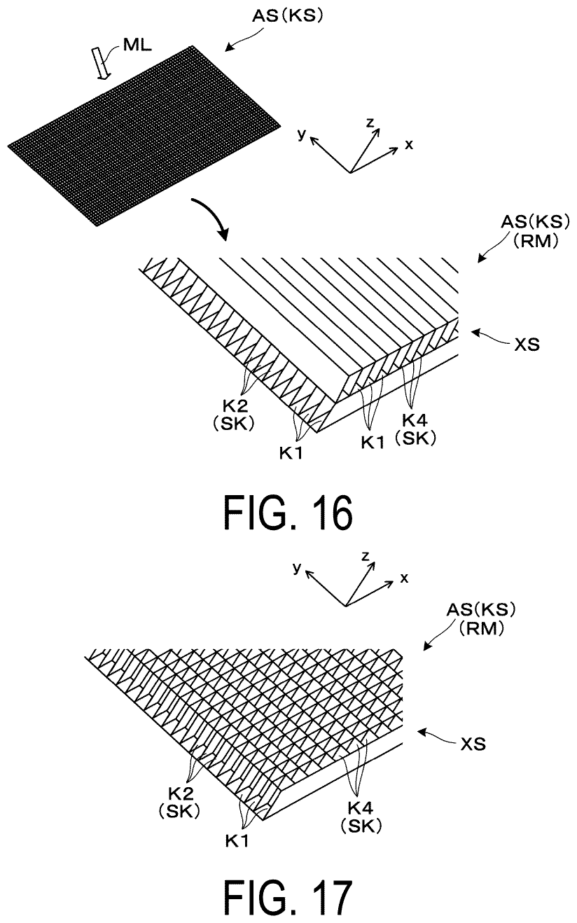

FIG. 16 is a diagram for explaining the angle suppression member AS of the fourth embodiment. In the embodiment, the angle suppression member AS includes, in addition to the light shielding region K2 extending in a longitudinal direction which is a predetermined direction, a light shielding region K4 extending in a short direction which is a direction perpendicular to the predetermined direction. In the first virtual image display device 100A illustrated in FIG. 9, normally, stray light is likely to be generated in an up-down direction, but when a width of the prism light guiding member 48 in a lateral direction is short, there is a possibility that stray light due to wall surface reflection or the like is generated. Therefore, the angle suppression member AS has a cross structure XS in which the light shielding regions K2 and K4 are disposed in two different directions orthogonal to each other. In the example of FIG. 16, the angle suppression member AS is formed by crossing and overlaying two repeating structures KS respectively including the light shielding regions K2 and K4. Note that as illustrated in FIG. 17, the angle suppression member AS may be formed by crossing the light shielding regions K2 and K4 in one repeating structure KS. The light shielding region K2 in the longitudinal direction and the light shielding region K4 in the short direction may have the same height or pitch or may have different heights or pitches.

### Modification Examples and Others

These are descriptions of the present disclosure with reference to the embodiments. However, the present disclosure is not limited to the embodiments described above. It is possible to implement the present disclosure in various modes without departing from the spirit of the disclosure. For example, the following modifications can be made.

Although the HMD 200 includes the first virtual image display device 100A and the second virtual image display device 100B in the above description, the HMD 200 may be configured such that a single first virtual image display device 100A or the second display device 100B is supported in front of the eye by the supporting device 100C.

In the cover member 52, the compensation flat plate 55 can be omitted. In this case, the quarter wavelength plate 51 is disposed only in a range of the second lens 53, and the second lens 53 is covered with the compensation lens 54.

In the second flat plate member 50, the cover member 52 may be omitted.

In the first prism 41 of the first flat plate member 40, the incident optical surface 41a may be omitted. In this case, an optical system from which the lens portion 44 is omitted is obtained.

The first lens 30 is not limited to a lens joined to the first image forming element 11a, and may be a lens disposed separately from the first image forming element 11a.

The oblique mirror portion IM may be a half mirror. The half mirror reflects a part of the image light ML and a part of the external light OL and partially transmits the image light ML and the external light OL. As an example, a reflectance and a transmittance of the half mirror may be 50%. The half mirror is formed of, for example, a dielectric multilayer film configured of a plurality of dielectric layers having an adjusted film thickness. The half mirror may be a single-layer film or a multilayer film of metal such as Al or Ag having an adjusted thickness. The half mirror is formed by, for example, lamination using vapor deposition.

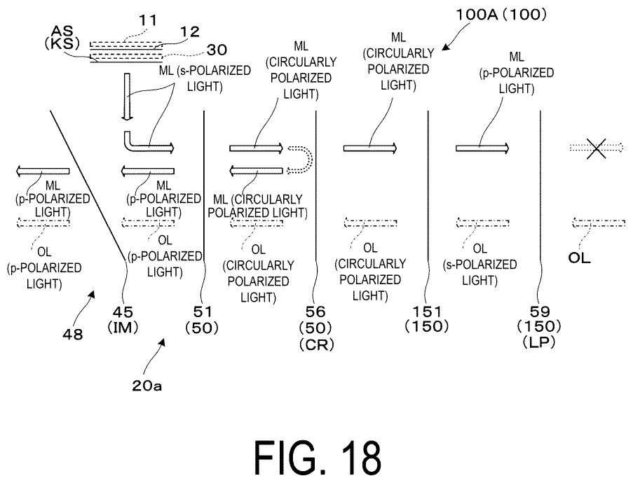

As illustrated in FIG. 18, in the first virtual image display device 100A, an s-polarized light transmissive polarizing plate 12 may be disposed, for example, between the first lens 30 and the display element 11 in the first display unit 20a. In addition, in the first display unit 20a, a third flat plate member 150 is added on the outside world side of the second flat plate member 50. The third flat plate member 150 is an image light shielding portion LP. The third flat plate member 150 includes an outer quarter wavelength plate 151 provided on the outside world side of the transmissive mirror 56 or the condensing and reflecting portion CR, and a polarizing plate 59 provided on the outside world side of the outer quarter wavelength plate 151. That is, the first display unit 20a has a structure in which the quarter wavelength plate 51 on an inner side and the quarter wavelength plate 151 on an outer side are disposed between the inner polarization separation film 45 on the inner side and the outer polarizing plate 59 on the outer side. The polarizing plate 59 selectively absorbs the image light ML transmitted through the outer quarter wavelength plate 151 according to a polarization direction.

The image light ML being circularly polarized light transmitted through the transmissive mirror 56 becomes p-polarized light by passing through the outer quarter wavelength plate 151, is incident on the polarizing plate 59, and is mostly shielded by the polarizing plate 59. That is, the image light ML is shielded by the third flat plate member 150 and does not leak outward. Since the image light ML can be prevented from being observed from outside, privacy can be secured. On the other hand, the external light OL incident on the polarizing plate 59 becomes only s-polarized light by passing through the polarizing plate 59, becomes circularly polarized light by passing through the outer quarter wavelength plate 151, and partially passes through the transmissive mirror 56. The external light OL being circularly polarized light partially transmitted through the transmissive mirror 56 becomes p-polarized light by passing through the inner quarter wavelength plate 51, is transmitted through the polarization separation film 45, and is incident on the pupil position PP (see FIG. 1).

A direct virtual image type virtual image display device in a specific aspect includes a display element configured to emit image light, a first lens on which the image light from the display element is incident, an angle suppression member disposed on an emission side of the first lens, a first prism on which the image light passing through the first lens is incident, a second prism joined to the first prism and forming a prism light guiding member having a parallel flat plate shape, an oblique mirror portion provided at a joint between the first prism and the second prism and configured to reflect at least a part of the image light guided in the first prism, a plano-convex second lens disposed to face an outer surface of the first prism on which the image light reflected by the oblique mirror portion is incident, a transmissive mirror formed above a convex surface of the second lens and configured to partially reflect the image light reflected by the oblique mirror portion toward the oblique mirror portion, and a quarter wavelength plate disposed between the outer surface of the first prism and a flat surface of the second lens.

In the above virtual image display device, in order to directly form a virtual image without forming an intermediate image, refractive power is ensured by the first lens, the second lens, and the transmissive mirror, and it is possible to ensure a magnification ratio while suppressing an increase in an optical path length and to avoid an increase in a size of an optical system. In addition, by providing the angle suppression member, it is possible to prevent occurrence of unnecessary unexpected reflection in the prism light guiding member and to reduce stray light caused by the unexpected reflection.

In the virtual image display device in a specific aspect, the angle suppression member has a light shielding repeating structure extending in a predetermined direction.

In the virtual image display device in a specific aspect, the angle suppression member is a louver member in which a plurality of light shielding slat-like members are arranged.

In the virtual image display device in a specific aspect, the angle suppression member controls an angle of light intersecting an axis perpendicular to a longitudinal cross-section of the prism light guiding member.

In the virtual image display device in a specific aspect, the angle suppression member has a size corresponding to the first lens, and is disposed between the first lens and the first prism. In this case, it is possible to restrict an incident angle of the image light incident on the first prism.

In the virtual image display device in a specific aspect, the angle suppression member is disposed on a pupil position side of the first prism. In this case, by providing the angle suppression member at an inner surface of the first prism, stray light can be further suppressed.

In the virtual image display device in a specific aspect, the angle suppression member includes a transmission region that transmits the image light, and light shielding regions arrayed at a predetermined pitch and a predetermined height as the repeating structure. By adjusting the pitch and height of the repeating structure, it is possible to appropriately shield a light beam of the image light having an angle at which stray light is generated.

In the virtual image display device in a specific aspect, the light shielding region is a light shielding body that is rectangular in cross-sectional view. In this case, the design of the repeating structure can be simplified.

In the virtual image display device in a specific aspect, the light shielding region is a light shielding body having any one of a triangular shape and a trapezoidal shape in cross-sectional view, and in the angle suppression member, a total area of the light shielding region at a center is smaller than a total area of the light shielding regions at both ends in a direction perpendicular to a predetermined direction in which the repeating structure extends. In this case, while the light shielding region is formed as the triangular or trapezoidal light shielding body to easily produce the repeating structure, by suppressing light shielding in a vicinity of a center of the angle suppression member where influence of stray light is small, it is possible to prevent a brightness change of an entire image from becoming large.

In the virtual image display device in a specific aspect, the second prism includes a light shielding member at a lower flat surface. In this case, stray light generated above a center of an image can be suppressed.

In the virtual image display device in a specific aspect, the oblique mirror portion includes a polarization separation film that selectively reflects the image light in accordance with a polarization direction, the first lens, the angle suppression member, the prism light guiding member, the polarization separation film, the second lens, the transmissive mirror, and the quarter wavelength plate constitute a single-microscope type imaging optical system that forms an erect image, and the first prism internally reflects the image light twice while diverging the image light. In this case, a distance from the display element to the transmissive mirror can be easily shortened, the prism light guiding member can be miniaturized, and the display element and the first lens can also be easily miniaturized.

In the virtual image display device in a specific aspect, the first lens includes a light incident surface being a flat surface joined to the display element and a light emission surface being a convex surface.

A direct virtual image type optical unit in a specific aspect includes a first lens on which image light from a display element that emits the image light is incident, an angle suppression member disposed on an emission side of the first lens, a first prism on which the image light passing through the first lens is incident, a second prism joined to the first prism and forming a prism light guiding member having a parallel flat plate shape, an oblique mirror portion provided at a joint between the first prism and the second prism and configured to reflect at least a part of the image light guided in the first prism, a plano-convex second lens disposed to face an outer surface of the first prism on which the image light reflected by the oblique mirror portion is incident, a transmissive mirror formed above a convex surface of the second lens and configured to partially reflect the image light reflected by the oblique mirror portion toward the oblique mirror portion, and a quarter wavelength plate disposed between the outer surface of the first prism and a flat surface of the second lens.

What is claimed is:

1. A direct virtual image type virtual image display device, comprising:
a display element configured to emit image light;
a first lens on which the image light from the display element is configured to be incident;
an angle suppression member disposed on an emission side of the first lens;
a first prism on which the image light passing through the first lens is configured to be incident;
a second prism joined to the first prism and forming a prism light guiding member having a parallel flat plate shape;
an oblique mirror portion provided at a joint between the first prism and the second prism and configured to reflect at least a part of the image light guided in the first prism;
a plano-convex second lens disposed to face an outer surface of the first prism on which the image light reflected by the oblique mirror portion is configured to be incident;
a transmissive mirror formed above a convex surface of the second lens and configured to partially reflect the image light reflected by the oblique mirror portion toward the oblique mirror portion; and
a quarter wavelength plate disposed between the outer surface of the first prism and a flat surface of the second lens.

2. The direct virtual image type virtual image display device according to claim 1, wherein
the angle suppression member includes a light shielding repeating structure extending in a predetermined direction.

3. The direct virtual image type virtual image display device according to claim 1, wherein
the angle suppression member is a louver member in which a plurality of light shielding slat-like members are arranged.

4. The direct virtual image type virtual image display device according to claim 1, wherein
the angle suppression member controls an angle of light intersecting an axis perpendicular to a longitudinal cross-section of the prism light guiding member.

5. The direct virtual image type virtual image display device according to claim 1, wherein
the angle suppression member has a size corresponding to the first lens, and is disposed between the first lens and the first prism.

6. The direct virtual image type virtual image display device according to claim 1, wherein
the angle suppression member is disposed on a pupil position side of the first prism.

7. The direct virtual image type virtual image display device according to claim 2, wherein
the angle suppression member includes a transmission region that transmits the image light, and as the light shielding repeating structure, a plurality of light shielding regions are arrayed at a predetermined pitch and a predetermined height.

8. The direct virtual image type virtual image display device according to claim 7, wherein
each of the light shielding regions is a light shielding body having a rectangular shape in a cross-sectional view.

9. The direct virtual image type virtual image display device according to claim 7, wherein
each of the light shielding regions is a light shielding body having any one of a triangular shape and a trapezoidal shape in a cross-sectional view, and
in the angle suppression member, in a direction perpendicular to the predetermined direction in which the light shielding repeating structure extends, a total area of the light shielding region at a center is smaller than a total area of the light shielding regions at both ends.

10. The direct virtual image type virtual image display device according to claim 1, wherein
the second prism includes a light shielding member at a lower flat surface.

11. The direct virtual image type virtual image display device according to claim 1, wherein
the oblique mirror portion includes a polarization separation film that selectively reflects the image light in accordance with a polarization direction,
the first lens, the angle suppression member, the prism light guiding member, the polarization separation film, the second lens, the transmissive mirror, and the quarter wavelength plate constitute a single-microscope type imaging optical system that forms an erect image, and
the first prism is configured to internally reflect the image light twice while diverging the image light.

12. The direct virtual image type virtual image display device according to claim 1, wherein
the first lens includes a light incident surface being a flat surface joined to the display element and a light emission surface being a convex surface.

13. A direct virtual image type optical unit, comprising:
a first lens on which image light from a display element that emits the image light is configured to be incident;
an angle suppression member disposed on an emission side of the first lens;
a first prism on which the image light passing through the first lens is configured to be incident;
a second prism joined to the first prism and forming a prism light guiding member having a parallel flat plate shape;
an oblique mirror portion provided at a joint between the first prism and the second prism and configured to reflect at least a part of the image light guided in the first prism;
a plano-convex second lens disposed to face an outer surface of the first prism on which the image light reflected by the oblique mirror portion is configured to be incident;
a transmissive mirror formed above a convex surface of the second lens and configured to partially reflect the image light reflected by the oblique mirror portion toward the oblique mirror portion; and
a quarter wavelength plate disposed between the outer surface of the first prism and a flat surface of the second lens.
